(19) United States
(12) Patent Application Publication
(10) Pub. No.: US 2013/0282919 A1
(43) Pub. Date: Oct. 24, 2013

(54) Data Migration Into And Out Of The Cloud Via A Data Kiosk/System

(71) Applicants: Eugene Paul Richards, III, Mount Holly, NJ (US); Satish Hemachandran, Newnan, GA (US); Jeffrey S. McGovern, West Berlin, NJ (US)

(72) Inventors: Eugene Paul Richards, III, Mount Holly, NJ (US); Satish Hemachandran, Newnan, GA (US); Jeffrey S. McGovern, West Berlin, NJ (US)

(73) Assignee: SunGard Availability Services LP, Wayne, PA (US)

(21) Appl. No.: 13/452,549

(22) Filed: Apr. 20, 2012

(51) Int. Cl. G06F 15/173

(52) U.S. Cl. 709/238

(57) ABSTRACT

A kiosk for migrating customer data into or out of a production cloud environment without impacting the production cloud environment is provided. Aspects of the kiosk include: i) supporting customer data migration that require physical or network access and ii) separating data migration traffic from production traffic.

### BACKGROUND

The users of data processing equipment increasingly find cloud-based Information Technology (IT) resources to be a flexible, easy, and affordable way to build and access the equipment and services they need. By moving infrastructure and applications to cloud based servers accessible over the Internet, these users are free to access resources that exactly fit their requirements at the outset, while retaining the option to adjust with changing future needs on a “pay as you go” basis. Cloud-based services bring this promise of scalability to allow expanding servers and applications as business needs grow, without having to spend for unneeded hardware resources in advance. Additional benefits provided by professional level cloud service providers include access to equipment with superior performance, security, disaster recovery, and easy access to information technology consulting services.

### SUMMARY

Cloud resources can include a number of data processing functions accessible through a cloud services provider, such as cloud storage, cloud computing, cloud networking, and other aspects of complete cloud production environments. Regardless of the type and/or extent of cloud resources utilized, the users of cloud services quite often need to move data between their own data processing environment and the production cloud environment operated by a cloud service provider.

Merely using existing resources available from the production cloud environment to move customer data, also called “cloud migration” or simply “migration,” can be difficult to administer given different file formats. In addition, these files to be migrated can vary from small (text files) to very large in size (such as databases or application programs); While small files can be transferred through the network using protocols like File Transfer Protocol (FTP), it can become time-consuming to move large amounts of data over the finite bandwidth connection between the customer's own environment and the production cloud.

Even the availability of cloud resources (storage, computing, and networking) can be impacted by moving files, negatively affect any production applications running in the same production environment. For example, using the same path used for carrying production traffic to move customer data can cause latency in the production traffic. The introduced latency may then cause virtual machines running in the production cloud environment to stop running momentarily or cause some other undesirable result.

What is needed is an entry point or “kiosk” for migrating customer data into or out of a production cloud environment without impacting, or at least minimizing the impact on, operation of the production cloud environment itself. The migration kiosk will typically have one or more of the following characteristics:
support for multiple digital and physical file formats;
facilitate electronic data transfer via the interne for small or medium files) as well as physical device transfers (e.g. physical delivery of non-volatile storage devices such as disk drives, Universal Serial Bus (USB) memory sticks, data appliances. storage arrays, etc.) for large files;
serve as a secure landing zone for the customer data so that the customer is assured that their data cannot be accessed by other customers of the cloud service; and/or
integrated into the production cloud through a pathway dedicated to migration which is separate from the pathways used for production traffic for customer applications.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments of the present invention.

FIG. 1 is a high level diagram of a production cloud environment and a cloud migration kiosk.

FIG. 2 illustrates use of the cloud migration kiosk in more detail.

FIG. 3 shows the use of dedicated routing paths for migrating data from the kiosk to the production cloud.

FIG. 4 is a user interface screen such as may be accessed through a cloud management system and showing a Virtual Data Center (VDC) configuration.

FIG. 5 is a screen shot showing the user specifying upload of a file to the cloud migration kiosk via a separate migration path.

FIG. 6 is another user's view of information concerning the VDC; note server “web2” has no file mounted.

FIG. 7 is a user interface screen to request mounting of a file located on the kiosk.

FIG. 8 illustrates how the user may specify a destination resource for a file previously stored by the kiosk and to be migrated to the production cloud.

FIG. 9 is a confirmation screen displayed after the file is migrated.

FIG. 10 is screen shot of the user confirming that the file has been mounted on the desired machine (“web2”).

### DETAILED DESCRIPTION

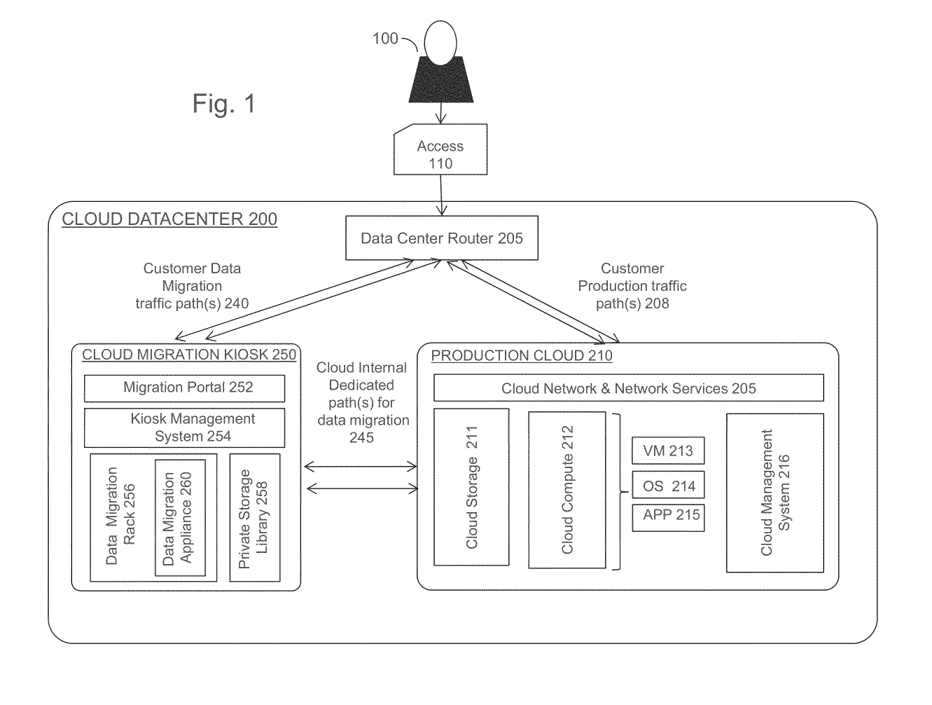

FIG. 1 shows an illustrative example of a cloud data center 200 operated by a cloud service provider that makes use of a cloud migration kiosk 250 according to the teachings herein. The cloud data center 200 includes numerous network and other data processing infrastructure elements (shown in FIG. 1 as boxes) interconnected to one another by network connections, some of which are redundant (shown in FIG. 1 as duplicate lines).

The cloud data center 2005 provides a number of data processing resources such as cloud storage 211, cloud compute 212, and/or cloud network 205 services to many different cloud customers (or users) 100, for example, to run their business applications. While each customer 100 uses its own set of resources, typically no one customer owns the equipment providing these resources; rather that equipment is owned and operated by a cloud services provider.

As will be described in some detail, the cloud migration kiosk 250 serves as a secure “landing zone” for moving customer data into or out of the production cloud environment 210. Namely, the kiosk 250 receives data from or provides data to the customers of the cloud service. Moving or migrating customer data directly to or from the production cloud environment 210 machines that would otherwise generate “migration traffic” that is undesirable. The migration traffic may include data that encompasses virtual machine definition (or configuration) files, operating system upgrades, applications, database files, media files, and other digital files (i.e., customer data 140) that are often extremely large in size.

In order to minimize the impact on the production cloud environment 210, the kiosk 250 separates this migration traffic from the normal production traffic by providing an alternate path 240 for migration traffic data into or out of the production cloud environment 210.

While customer data is being moved to or from the production cloud environment 210 over migration traffic paths 240, customers 100 can continue to actively use the resources in production cloud 210 with minimal impact on their operation and minimal impact on production traffic paths 208. This is because production traffic is carried over production traffic paths 208 that are different from migration traffic paths 240.

Because the two types of paths are physically separate, the kiosk 250 is used as in intermediate storage space for migrating customer data 140 to the production cloud environment 210. The kiosk 250 is multi-tenant, meaning that multiple customers 100 can access the kiosk 250 to migrate data to their respective resources in the production cloud environment 210. In a convenient embodiment, the kiosk 250 labels or tags the data being moved with the destination (e.g., a specific cloud storage 211, cloud compute 212 or cloud network 205 resource). The kiosk 250 ensures that data is moved to the correct resource(s) belonging to the correct customer over internal dedicated paths 245 and using security mechanisms such that each customer 100 remains unaware of other customers 100 and cannot access other customer's data that might be stored in the kiosk 250.

More specifically, the cloud data center 200 includes a production cloud 210 which itself further includes one or more cloud based information technology (IT) resources such as cloud storage 211, cloud compute 212 and/or cloud network and cloud network services 205. In the typical arrangement the service provider makes the cloud data center 200 available to the users 100 through some access 110 such as the Internet. It is also typical that a cloud management system 216 provides a management interface so that users 100 can configure one or more of the resources available to them in the production cloud 210.

It may be a case that a given user 100 has only paid for and only has access to cloud storage 211 such as may be provided by a storage array in the cloud data center 200. However, another user 100 may have access to both cloud storage 211 and cloud compute 212 resources; the cloud computing resources be implemented in one or more physical or virtual data processing machines. It is common (but not required) that the cloud compute resources 212 are virtualized such that the user 100 actually has access to multiple virtual machines (VMs) 213 to implement the cloud compute resources 212. The VMs 213 may further include operating systems (OS) 214 and applications (APP) 215. A cloud network and network services piece 205 may also be provided to the user 100. If the user has access to network services 205, cloud compute resources 212 and cloud storage 210 it becomes possible for the user 100 to then implement a Virtual Data Center (VDC).

One or more data center routers 205 carry customer production traffic over production paths 208 to and from the production cloud 210. So for example, in a manner which is well known, customer 100 may use the Internet to access to a database application 215 hosted on a cloud compute resource 212. The database application 215 may in turn access data stored in cloud storage 210, providing the results of say a database lookup back over the production paths 208. The user 100 thus accesses his or her database application 215 through the production traffic paths 208 during normal execution of his or her application 215.

It should be understood that customer data migration traffic paths 240 and customer production traffic paths 208 may share different ports on data center router 205 and/or may each have their own dedicated routers and/or switches in the data center 200. What is important is that migration data not enter production cloud 210 directly but rather first be passed to cloud migration kiosk 250 over migration traffic paths 240.

As part of an initial provisioning of one a cloud storage 211, cloud compute 212, or even network resource 205, the user may need to move one or more files from his own environment into the production cloud 210. As mentioned above, the user does not use the production paths 208 for this, but instead uses cloud migration kiosk 250. The kiosk 250 consists of a number of different systems that also provide specific types of computing resources, storage resources and network access for data migration into or out of production cloud 210. Access by user 100 to cloud migration kiosk 250 is through data migration traffic paths 240 that are separate and distinct from production traffic paths 208.

The cloud migration kiosk 250 may consist of a migration portal 252, a kiosk management system 254, a private storage library 258, and a data migration rack 256. The user 100 has several different options available for providing and/or uploading data to or from the cloud migration kiosk 250. Once the data is migrated from the users environment over migration paths 240 into kiosk 250, the private storage library 258 and/or data migration rack 256 provide a secure “landing zone” for the users 100 data in the migration kiosk 250.

Upon activation, such as through migration portal 252, the user 100 may cause his data previously uploaded to private library 258 ort migration rack 256 to be moved to data migration rack 256. This then causes internal dedicated paths 245 to initiate data transfer over an internal migration path 245 from cloud migration kiosk 250 to one or more destination resources (such as cloud storage 211 or cloud compute 212) in the production cloud 210. That is, the user 100 may for example be upoloading data to a database or web server application 215, but may also be specifying attributes of his cloud compute resources 211 including definitions file for a VM 213, system images for his OS 214 and/or application software 215.

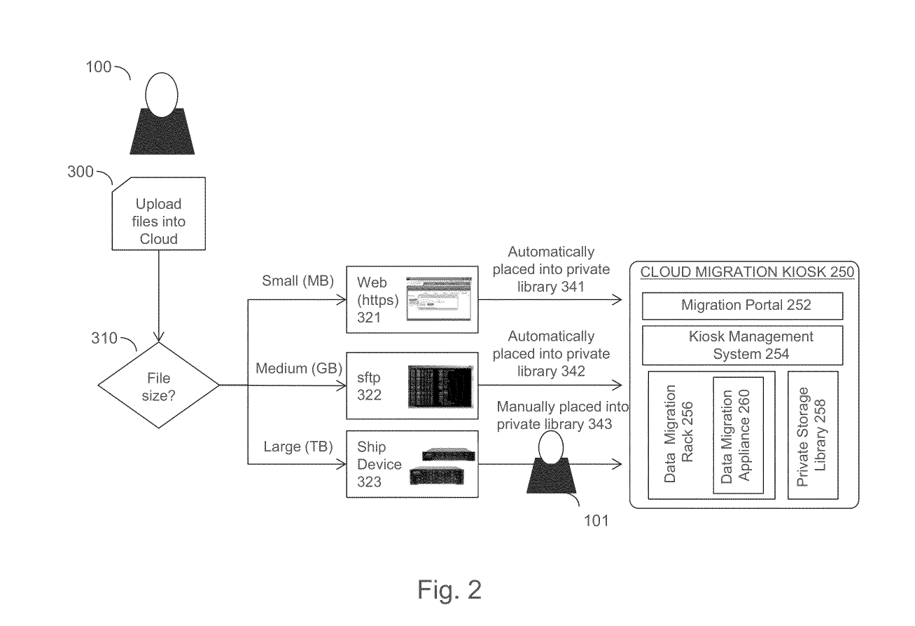

FIG. 2 illustrates a couple of different ways that the user 100 moves data into the cloud migration kiosk 250. Here the user 100 has reached a state 300 in which she or he has information such as in the form of one or more files that they wish to migrate from their own environment into production cloud environment 210.

In the next state 310 the user 100 makes a decision, typically depending upon the size of the file or the files to be moved, as to which of several logical paths are to be taken.

For example, if the file is relatively small, such as on the order of megabytes, the file can be uploaded over a web type connection such as a secure HTTP in state 321 to private storage library 258. If this is the case, the user making use of kiosk management system 216 which itself communicates with migration portal 252 interacts with the user 100 to identify a file to be uploaded to the cloud migration kiosk 250, and into a portion of private storage library 258 that is securely accessible only by the specific user 100 and not other users. This step is indicted by the action arrow 341 in FIG. 2.

If the file size is relatively medium, the user may wish to use transfer the file using other protocols but still with a live network connection for migration. This may be the case for files are in the range of 10 to 100 gigabytes, for example. In this instance the user 100 may have access to a secure FTP site in state 322. The file can be moved into private library 258 in state 342 from the secure FTP site, using the customer data migration traffic paths 240 once again, and without impacting customer production traffic paths 208.

In a third result of the test of step 310, the file is determined to be relatively large in such of the order of terabytes (TB). In this instance state 323 is rendered desirable where the user decides to physically ship the media containing the data to the location in which the cloud data center 200 is operated. This may include for example shipping the storage media itself, which may range from very small devices such as universal serial bus (USB) memory keys, or physically large devices which may be network attached storage arrays that comprise one or more racks of many disk drives. In this instance an administrator 101 associated with the service provider who is operating cloud data center 200 manually connects the physical devices such that they are accessible to the kiosk 250 via the data migration rack 256.

As non-limiting example, the data migration rack 256 may support access by a range of physical storage devices that may originate from a variety of users, including compact disk/digital versatile disk (CD/DVD), universal serial bus (USB) devices formatted in new technology file system (NTFS), third extended file system (EXT3) or virtual machine file system (VMFS), to name a few format examples, network-attached storage (NAS) devices, storage arrays, and other means of physical access to stored data. The provider then physically activates the corresponding physical device and/or connects the storage media to the data migration rack 256 making it accessible to the kiosk 250. For very large files or data sets, the provider could also use a standard migration appliance 260 that can be shipped to customers' sites for data migration. Customers can copy data onto the migration appliance 260 and ship back to the provider. The provider can then place the appliance into the data migration rack 256 for copying data into the customers' virtual data center.

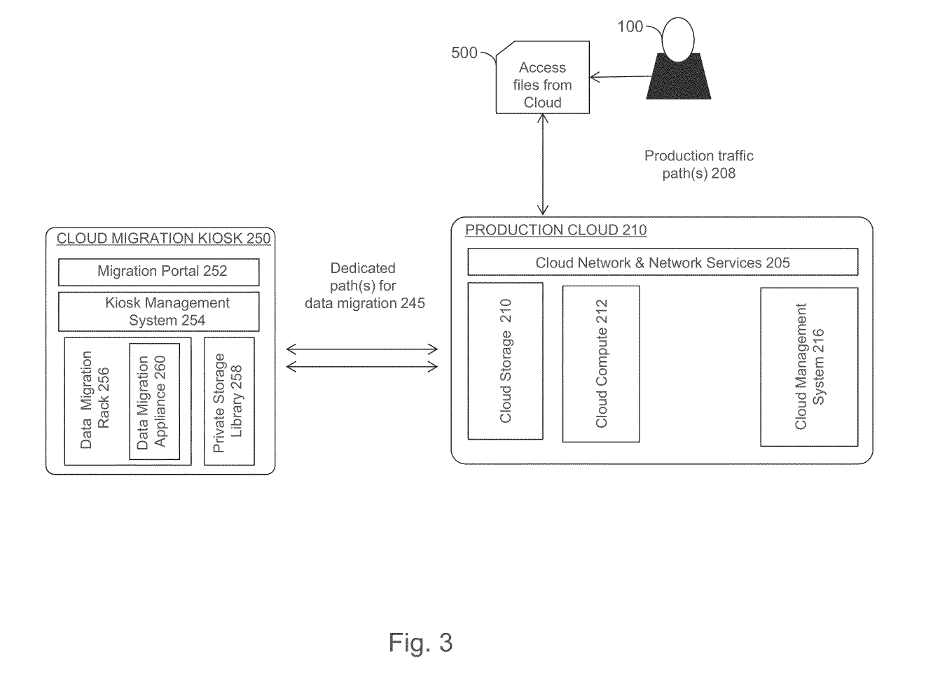

Once the files have been migrated (either over a network connection to private library 258 or by physical shipment via data migration rack 256) a further step of shifting files into the cloud production environment 210 may take place. This is illustrated in FIG. 3. Here the file(s) move from the private storage 258 or data migration rack 256 under command from user 100, using migration portal 252. Data then moves from the private storage library 258 and/or migration rack 256 to an indicated destination over the data migration dedicated paths 245 between migration kiosk 250 and production cloud 210. Such destination may for example be cloud storage 210, one or more files associated with a cloud compute resource 212, and/or cloud network resource 205.

A few non-limiting examples of the types of customer data that can be handled by the cloud kiosk 250 include:

A) Supported VMWARE Infrastructure Virtual Machines:
1) ESX Server 2.5 (If the VM is managed by Virtual Center 2.x)
2) ESX 3.0, 3.5, and 4.0
3) ESXi 3.5 and 4.0 Embedded
4) VMWARE vCenter Server 2.0, 2.5, 4.0

B) Supported VMWARE Desktop Virtual Machines:
1) VMWARE Workstation 4.0, 5.0, 6.0, 6.5
2) VMWARE Player 1.0, 2.0, 2.5
3) VMWARE Fusion 1.0, 2.0
4) VMWARE ACE 1.0, 2.0, 2.5
5) VMWARE Server 1.0, 2.0

C) Supported Backup Image or Third-Party Virtual Machines:
MICROSOFT Virtual PC 2004 or 2007
MICROSOFT Virtual PC 2004 or 2007
MICROSOFT VirtualServer 2005
PARALLELS Desktop 2.5, 3.0 or 4.0 for Mac
VMWARE Consolidated Backup (WINDOWS Converter Standalone server only)
SYMANTEC Backup Exec System Recovery 6.5, 7.0, 8.0 (WINDOWS Converter Standalone server only)
SYMANTEC LiveState Recovery 3/6 (WINDOWS Converter Standalone server only)
NORTON Ghost versions from 9 to 14 (WINDOWS Converter Standalone server only)
ACRONIS True Image Backup (WINDOWS Converter Standalone server only)
SHADOWPROTECT Desktop, Server, SBS, IT, etc. versions from 2.0 to 3.2 (WINDOWS Converter Standalone server only)

In addition to various types and formats of data, the cloud kiosk 250 also supports various sizes of data files. Typical sizes are on the order of gigabytes to terabytes of data.

The cloud kiosk 250 establishes and maintains the migration traffic paths 245 and from the resources 211, 212, 205 in production cloud 210. In a convenient embodiment, the cloud kiosk 250 establishes the migration traffic paths 240, 245 on a temporary and as-needed basis. For example, the cloud kiosk 250 establishes a migration traffic path 240 when the user requests an internet file transfer. The cloud kiosk then establishes the internal migration path(s) 245 when there is an indication of new migration data to be sent to cloud production environment 210, regardless of whether it is stored in the private storage area 258 ormigration rack 256. The cloud kiosk 250 “tears down” or removes these temporary migration traffic paths 240, 245 when there is no longer any data to move. In this way, network resources may be conserved.

There may be any number of migration traffic paths 240, 245 between the cloud kiosk 250 and the user 100, and production cloud 210. In one embodiment, the number of migration traffic paths 240, 245 depends the amount of migration traffic. In another embodiment, migration traffic is load balanced over several migration traffic paths. In yet another embodiment, a number of migration traffic paths (and/or associated bandwidth) available to a customer 100 for cloud migration depends a level of service (i.e., according to service level agreement or “SLA”) paid for by that customer.

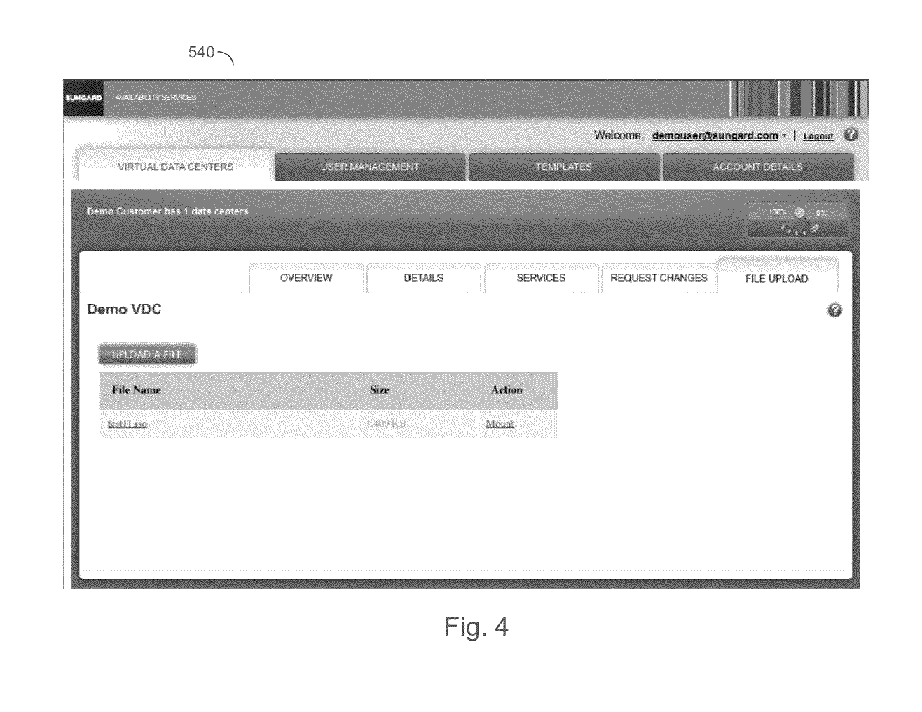

FIG. 4 is an example screen which the user 100 may see when accessing cloud management system 216. It should be understood that the data migration portal 252 cooperates with the cloud management system 216 during the processes described below, such that cloud management 216 may orchestrate the user's access to the migration portal 252.

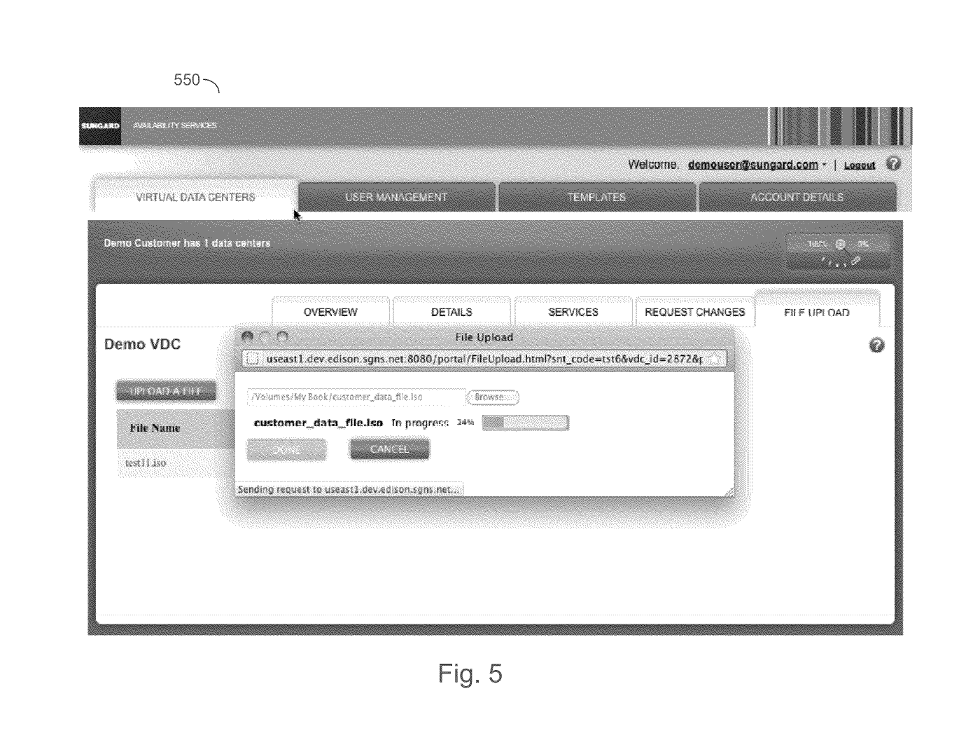

Regardless of whether this access occurs directly or not the user 100 may see a user interface screen such as shown in FIG. 4. The user has defined a cloud compute resource 212 in his production cloud 210 that includes a virtual data center (VDC) he calls “Demo VDC”. A button is provided to provide for uploading a file from the user's environment. Upon activating the button, the user is then presented with a screen 550 such as shown in FIG. 5. Here, the user may browse data resources that are available to his local environment and select one that is to be uploaded to kiosk 250. Here the file of interest is a relatively small operating system image file and that the user has selected is to be uploaded via secure FTP to one of his compute resources 212.

Upon receiving this command from the user 100, the cloud management system 216 then signals the kiosk management system 254 to open up the requests migration path(s) 240 and allocate a file in the private storage library 258. A progress bar may be illustrated to show the users current progress in uploading the file to the kiosk 250.

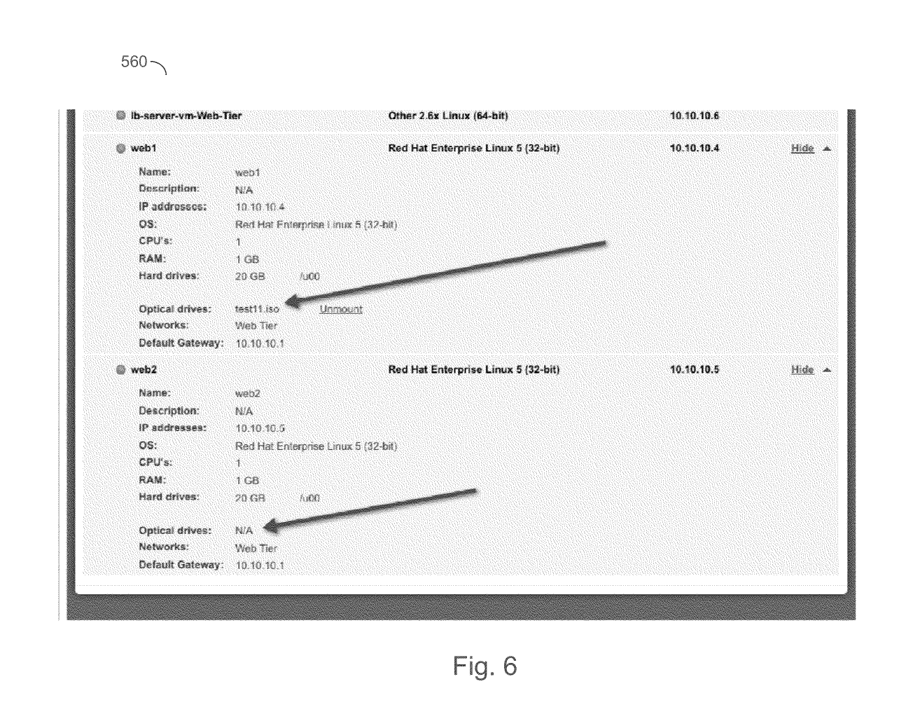

FIG. 6 presents another example screen 560 that the user may see before his file is uploaded. Here user 100 can see that an optical drive such as a CD ROM associated with a first web server “web 1” in his VDC already has an operating system image mounted, but that his web server “web2” does not. The web2 VM has a free virtual optical drive, and the user wishes to use an operating system such as Red Hat Enterprise Linux 5. But the image is not yet mounted.

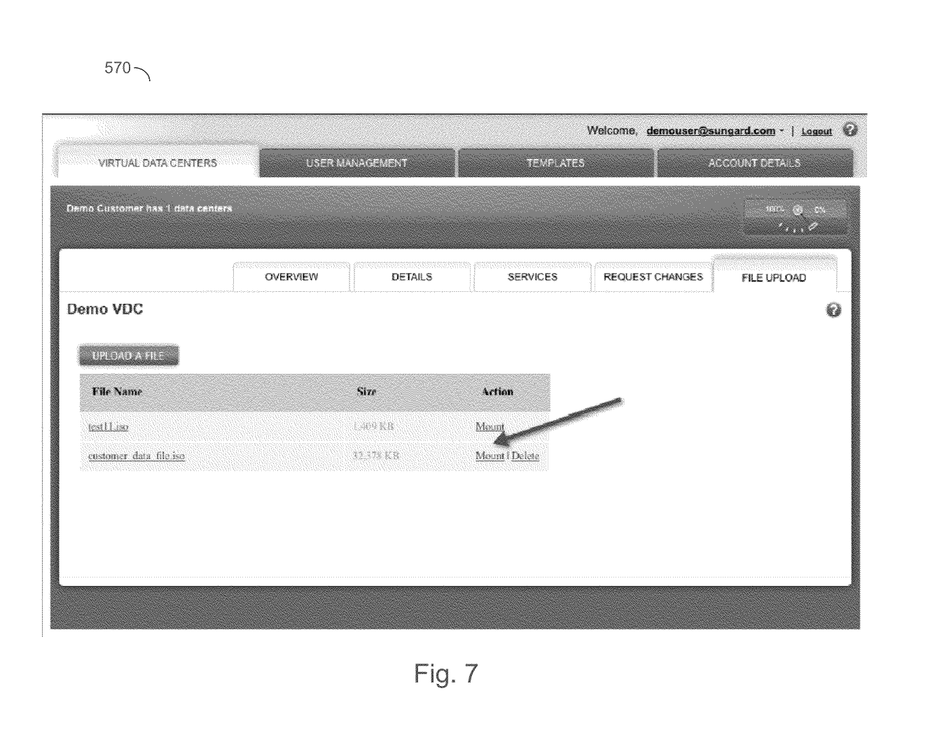

However, after the upload process of FIG. 5 completes, the user can then return to the file upload status page of his demo VDC, such as shown in FIG. 7, and see that he now has a new image file “customer _data file.iso” available to him for mounting.

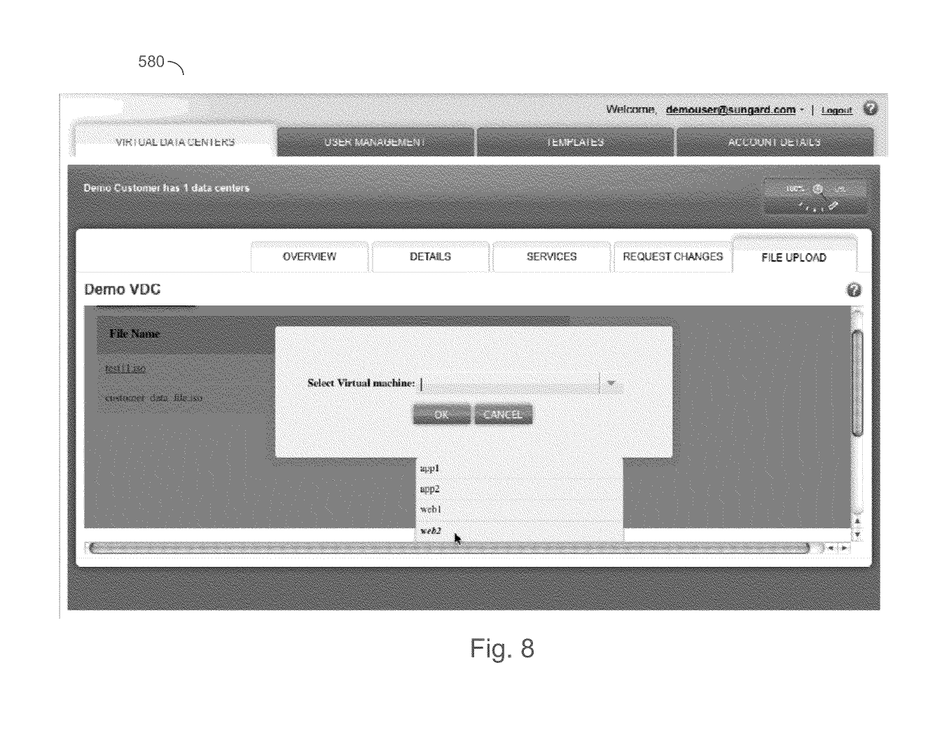

He can then now select an action to mount that file (see FIG. 8) which then prompts the cloud management system 216 to show the user a drop down box type option to select a virtual machine on which he wishes to mount the image file. Here he can indicate, by clicking in the drop down box, that the new image file is to be mounted on his VM called “web2”.

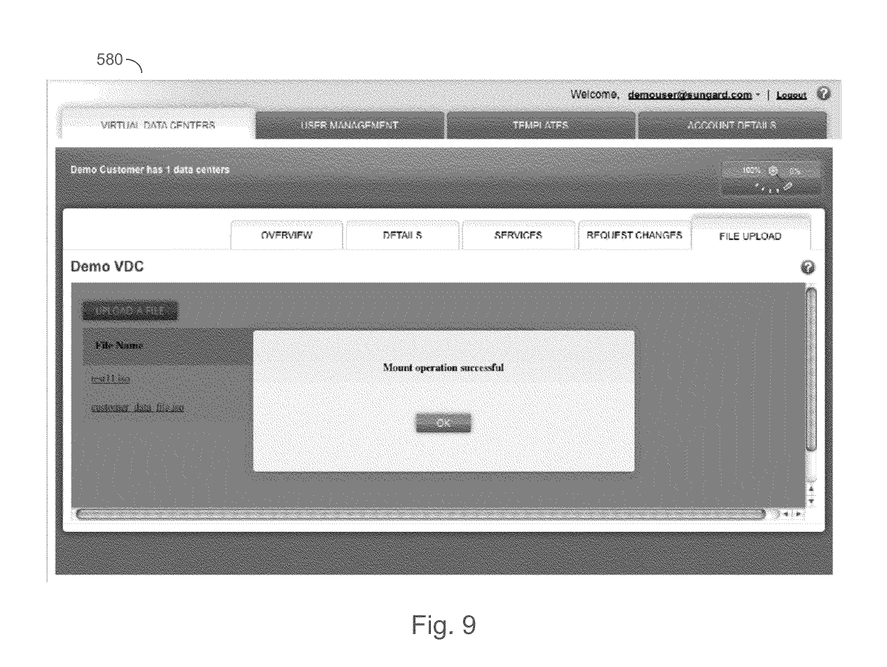

Once the mount operation is successful a screen such as FIG. 9 can be shown to confirm the successful mount.

Now to reach this point it should be understood that the ISO file was migrated from the private storage library 258 location to which it was initially uploaded. The kiosk then established one or more internal migration paths 245 for data migration from kiosk 250 into production cloud 210, allowing the new file to now be moved into the production cloud. The cloud management system 216 then could have the file become associated as the OS file 214 for a specific cloud compute resource, that is, the virtual machine 213 called “web2”.

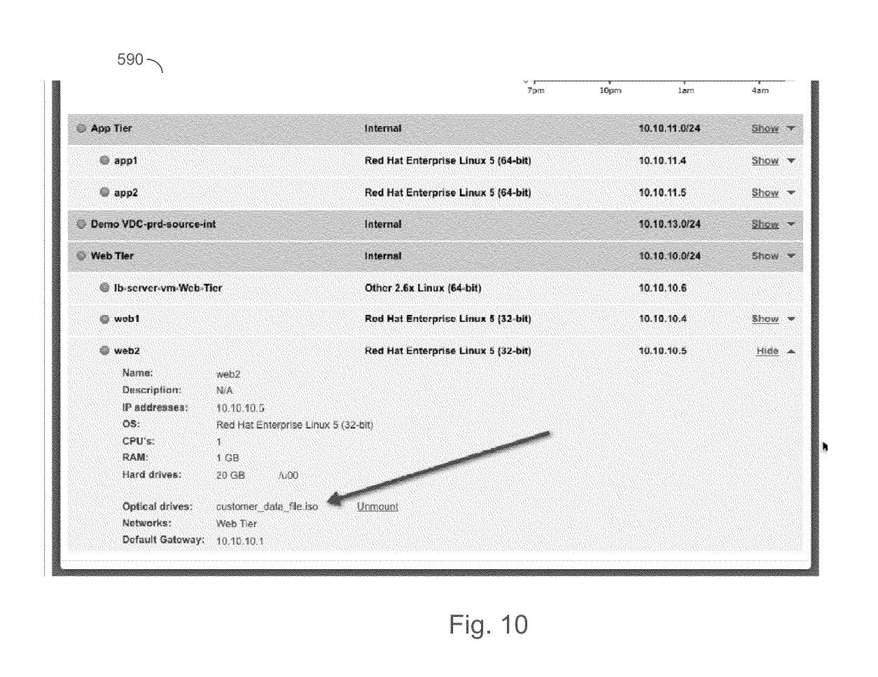

In a next state is a screen 590 is shown as in FIG. 10 where the user then may go back to look at the configuration of the machines in his demo VDC. Here he can now confirm that the customer data file.iso has been mounted on a virtual optical drive on server “web2”.

It should be understood that the example embodiments described above may be implemented in many different ways. In some instances, the various “machines” described herein may each be implemented by a physical, virtual or hybrid general purpose computer having a central processor, memory, disk or other mass storage, communication interface(s), input/output (I/O) device(s), and other peripherals. The general purpose computer is transformed into the machines described above, for example, by loading software instructions into a data processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., processor, disk storage, memory, input/output ports, network ports, etc.) that enables the transfer of information between the elements. One or more central processor units are attached to the system bus and provide for the execution of computer instructions. Also attached to system bus are typically I/O device interfaces for connecting various input and output devices (e.g., keyboard, mouse, displays, printers, speakers, etc.) to the computer. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments may therefore typically be implemented in hardware, firmware, software, or any combination thereof.

A processor that executes the functions described above may be deployed in a cloud computing arrangement that makes available one or more physical and/or virtual data processing machines via a convenient, on-demand network access model to a shared pool of configurable computing resources (e.g., networks, servers, storage, applications, and services) that can be rapidly provisioned and released with minimal management effort or service provider interaction. Such cloud computing deployments are relevant and typically preferred as they allow multiple users to access computing resources as part of a shared marketplace. By aggregating demand from multiple users in central locations, cloud computing environments can be built in data centers that use the best and newest technology, located in the sustainable and/or centralized locations and designed to achieve the greatest per-unit efficiency possible.

In certain embodiments, the procedures, devices, and processes described herein constitute a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transitory machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); magnetic disk storage media; optical storage media; flash memory devices; and others.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It also should be understood that the block and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus the data processors described herein are intended for purposes of illustration only and not as a limitation of the embodiments.

1. A method for operating a production cloud comprising:
carrying production traffic to and/or from production data processing resources located within the production cloud and accessible to a customer over a production data traffic path;
providing a connection to a secure storage kiosk via one or more migration traffic paths that are separate from the production data traffic path; and
migrating customer data into and/or out of the production data processing resources via the secure storage kiosk over at least one migration traffic path that is separate from the production data traffic path.

2. A method as in claim 1 wherein the migrating step further comprises:
using a migration appliance that is physically sized to be shipped between a customer location and a service provider location for moving the customer data.

3. The method of claim 1 wherein at least one migration traffic path includes a network data interface configured to send and receive the customer data to and from a customer location.

4. The method of claim 3 wherein the migration traffic path supports access through the Internet using any one of: Hypertext Transfer Protocol Secure (HTTPS) or File Transfer Protocol (FTP).

5. The method of claim 3 wherein the migration traffic path is physical delivery of a storage device.

6. The method of claim 5 wherein the storage device is one of: compact disk (CD), digital versatile disk (DVD), universal serial bus (USB) device, network-attached storage (NAS) or combinations thereof.

7. The method of claim 1 further wherein the one or more migration traffic paths are selectively established between the secure storage kiosk and one or more production virtual data centers.

8. The method of claim 1 wherein the customer data is one or more of a virtual machine definition file, operating system upgrade, application or media file.

9. The method of claim 1 further wherein: the production data processing resources comprise one or more of a cloud storage, cloud compute, or cloud network resource.

10. The method of claim 1 wherein the connection between the secure storage kiosk and the production data resources comprises two secure connections, a first secure connection between a customer location and the secure storage kiosk, and a second secure connection between the secure storage kiosk and the production data resources.

11. An apparatus for accessing a data processing system comprising:
a first interface, for providing a product data traffic path for carrying production traffic to and/or from production data processing resources accessible to a customer;
a secure storage kiosk, for providing one or more migration traffic paths that are separate from the production data trafficpath, and for migrating customer data into and/or out of the production data processing resources over at least one migration traffic path that is separate from the production data traffic path.

12. The apparatus of claim 11 wherein the secure storage kiosk additionally comprises:
a migration data storage appliance that is physically sized to be shipped between a customer location and a service provider location for the production data processing resources.

13. The apparatus of claim 11 wherein the migration traffic path supports access through the Internet using any one of: Hypertext Transfer Protocol Secure (HTTPS) or File Transfer Protocol (FTP).

14. The apparatus 11 wherein the migration traffic path is physical delivery of a storage device.

15. The apparatus of claim 14 wherein the storage device is one of:
compact disk (CD), digital versatile disk (DVD), universal serial bus (USB) device, network-attached storage (NAS) or combinations thereof

16. The apparatus of claim 11 further wherein the one or more migration traffic paths provide a connection between the secure storage kiosk and one or more production virtual data centers.

17. The apparatus of claim 11 wherein the customer data is one or more of a virtual machine definition file, operating system upgrade, application or media file.

18. The apparatus of claim 11 further wherein: the production data processing resources comprise one or more of a cloud storage, cloud compute, or cloud network resource.

19. The apparatus of claim 11 wherein the connection between the secure storage kiosk and the production data resources comprises two secure connections, a first secure connection between a customer location and the secure storage kiosk, and a second secure connection between the secure storage kiosk and the production data resources.

20. A programmable computer system product for operaeting a production cloud, the programmable computer system product comprising one or more data processing machines that execute instructions retrieved from a storage media, the instructions for:
carrying production traffic to and/or from production data processing resources located within the production cloud and accessible to a customer over a production data traffic path;
providing a connection to a secure storage kiosk via one or more migration traffic paths that are separate from the production data traffic path; and
migrating customer data into and/or out of the production data processing resources via the secure storage kiosk over at least one migration traffic path that is separate from the production data traffic path
